(19) United States
(12) Patent Application Publication
(10) Pub. No.: US 2010/0129537 A1
(43) Pub. Date: May 27, 2010

(54) METHOD OF MANUFACTURING ELECTRONIC DEVICES OF RESISTING SCRAPE AND WEAR WITH NANOTECHNOLOGY

(75) Inventor: Chih-Hao Huang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/275,626

(22) Filed: Nov. 21, 2008

(51) Int. Cl. B05D 5/12

(52) U.S. Cl. 427/126.4; 427/58; 427/126.3

(57) ABSTRACT

A method of manufacturing electronic devices of resisting scrape and wear with nanotechnology is described hereinafter. Firstly, make an initial reactant into a coating solution of nanometer. Secondly, coat the coating solution of nanometer onto surfaces of an electronic product evenly. Lastly, put the electronic product coated with the coating solution of nanometer under a room temperature or a heating environment lower than 150 degrees centigrade to make the coating solution of nanometer dried for forming nanometer protective films on the surfaces of the electronic product, wherein the thickness of the nanometer protective film is substantially 10-20 microns. The nanometer protective film can protect the electronic product from being scraped and worn, and the thickness thereof is controlled to be 10-20 microns that ensures the aesthetic of the electronic product uninfluenced.

### BACKGROUND OF THE INVENTION

1. Field of the Invention

The present invention generally relates to a method of manufacturing electronic devices of resisting scrape and wear, and more particularly to a method of manufacturing electronic devices of resisting scrape and wear with nanotechnology.

2. The Related Art

With the development of electronic technology, various kinds of electronic products have been used in our daily life and living extensively. However, with the increase in service time of the electronic product, the surfaces of the electronic product are apt to be scraped and worn to result in aesthetic problems thereof. So the surfaces of the electronic product are usually covered with a layer of protective film for protecting the electronic product from being scraped and worn. The protective film is conventionally made of UV glue. A method for forming the protective film is described hereinafter. Firstly, the UV glue is coated onto the surfaces of the electronic product. Then the electronic product is put under the UV light having specific wavelengths to be shined for making the UV glue solidified so as to form the protective film on the surfaces of the electronic product. However, the conventional method needs a specific UV-shining device to make the UV glue solidified. Moreover, the UV glue has a relatively high cost that make the cost of the protective film made of the UV glue relatively higher. In addition, the protective film made of the UV glue is usually conspicuous on the surfaces of the electronic product that has an influence on the aesthetic of the electronic product.

### SUMMARY OF THE INVENTION

An object of the present invention is to provide a method of manufacturing electronic devices of resisting scrape and wear with nanotechnology. The method of manufacturing electronic devices of resisting scrape and wear with nanotechnology is described hereinafter. Firstly, make an initial reactant into a coating solution of nanometer. Secondly, coat the coating solution of nanometer onto surfaces of an electronic product evenly. Lastly, put the electronic product coated with the coating solution of nanometer under a room temperature or a heating environment lower than 150 degrees centigrade to make the coating solution of nanometer dried for forming nanometer protective films on the surfaces of the electronic product, wherein the thickness of the nanometer protective film is substantially 10-20 microns.

As described above, the coating solution of nanometer coated on the surfaces of the electronic product can be dried under the room temperature or the heating environment lower than 150 degrees centigrade to form the nanometer protective films on the surfaces of the electronic product so as to protect the electronic product from being scraped and worn. Therefore, the manufacturing process of the nanometer protective film costs relatively less. Moreover, the thickness of the nanometer protective film is controlled to be 10-20 microns that remains the aesthetic of the electronic product uninfluenced.

### DETAILED DESCRIPTION OF THE PREFERRED EMBODIMENT

A method of manufacturing electronic devices of resisting scrape and wear with nanotechnology according to the present invention is described hereinafter.

Firstly, make a proper initial reactant into a coating solution of nanometer, wherein the initial reactant can be metal alkane oxides, such as silicon dioxide, zirconium dioxide or aluminum trioxide and so on.

Secondly, coat the coating solution of nanometer onto surfaces of an electronic product evenly by way of spraying, dipping or roll-to-rolling.

Lastly, put the electronic product coated with the coating solution of nanometer under a room temperature or a heating environment lower than 150 degrees centigrade to make the coating solution of nanometer dry for forming nanometer protective films on the surfaces of the electronic product so as to protect the electronic product from being scraped and worn.

Wherein the greater the thickness of the nanometer protective film is, the stronger its ability of resisting scrape and wear will be. But the aesthetic of the electronic product is apt to be influenced if the nanometer protective film has an excessive thickness. Therefore, the thickness of the nanometer protective film is controlled to be 10-20 microns preferably in order to ensure that the aesthetic of the electronic product is not influenced.

An unlimited embodiment is described as following. In the unlimited embodiment, the coating solution of nanometer is made of the silicon dioxide. Coat the coating solution of nanometer onto a connecting wire and a shell of a mobile phone evenly, and then put the connecting wire and the shell of the mobile phone under a heating environment of 105 degrees centigrade to make the coating solution of nanometer dried so as to form nanometer protective films thereon, wherein the nanometer protective film has a thickness of 17 microns. Next, do a wear-resisting test to the connecting wire with a JIS C3004 testing machine. As a result, the wear-resisting ability of the connecting wire having the nanometer protective film thereon is improved by about 4.5%-9.3%. Lastly, do a scrape-resisting test to the shell of the mobile phone according to an ASTM D3363 testing standard. As a result, the scrape-resisting ability of the shell of the mobile phone having the nanometer protective film thereon is improved to 2-3H. Therefore, it is known from the above-mentioned unlimited embodiment that the shell of the mobile phone and the connecting wire respectively processed by the above-mentioned method can really resist scrape and wear well.

As described above, the method of manufacturing electronic devices of resisting scrape and wear with nanotechnology is achieved by way of coating the coating solution of nanometer on the surfaces of the electronic product and then making the coating solution of nanometer dry under the room temperature or the heating environment lower than 150 degrees centigrade for forming the nanometer protective films thereon so as to protect the electronic product from being scraped and worn. Therefore, the manufacturing process of the nanometer protective film made of the metal alkane oxides will cost relatively less. Moreover, the thickness of the nanometer protective film can be controlled so that the aesthetic of the electronic product will not be influenced.

What is claimed is:

1. A method of manufacturing electronic devices of resisting scrape and wear with nanotechnology, comprising the steps of:
making an initial reactant into a coating solution of nanometer;
coating the coating solution of nanometer onto surfaces of an electronic product evenly; and
putting the electronic product coated with the coating solution of nanometer under a room temperature or a heating environment lower than 150 degrees centigrade to make the coating solution of nanometer dried so as to form nanometer protective films on the surfaces of the electronic product, wherein the thickness of the nanometer protective film is substantially 10-20 microns.

2. The method as claimed in claim 1, wherein the initial reactant is metal alkane oxides.

3. The method claimed in claim 1, wherein the initial reactant is silicon dioxide, zirconium dioxide or aluminum trioxide.

4. The method as claimed in claim 1, wherein the coating solution of nanometer is coated on the surfaces of the electronic product by way of spraying, dipping or roll-to-rolling.
